(19) United States
(12) Patent Application Publication
(10) Pub. No.: US 2025/0327162 A1
(43) Pub. Date: Oct. 23, 2025

(54) MANUFACTURING METHOD FOR AN ALUMINUM ALLOY MEMBER, AND SHOT PEENING APPARATUS

(71) Applicant: SINTOKOGIO, LTD., Nagoya-shi (JP)

(72) Inventors: Yuta KIMURA, Nagoya-shi (JP); Yuji KOBAYASHI, Nagoya-shi (JP)

(73) Assignee: SINTOKOGIO, LTD., Nagoya-shi (JP)

(21) Appl. No.: 19/177,939

(22) Filed: Apr. 14, 2025

(30) Foreign Application Priority Data
Apr. 19, 2024 (JP) 2024-068423

(51) Int. Cl. C22F 3/00; B24C 1/10

(52) U.S. Cl. CPC C22F 3/00; B24C 1/10

(57) ABSTRACT

A manufacturing method for an aluminum alloy member includes preparing an aluminum alloy member composed of an aluminum alloy, and performing shot peening on the aluminum alloy member in a range in which a speed of the shot when contacting the aluminum alloy member is from 1 m/s to 7 m/s to impart residual stress to the aluminum alloy member.

### CROSS-REFERENCE TO RELATED APPLICATION

This application is based on Japanese Patent Application No. 2024-068423 filed with Japan Patent Office on Apr. 19, 2024, the entire contents of which are hereby incorporated by reference.

### TECHNICAL FIELD

The present disclosure relates to a manufacturing method for an aluminum alloy member, and a shot peening apparatus.

### BACKGROUND

Japanese Patent Application Laid-Open No. 2006-188720 discloses a manufacturing method for an aluminum alloy member composed of an aluminum alloy. The manufacturing method includes a step of performing shot peening on the aluminum alloy member. In this shot peening, a shot medium having a smaller particle size than a conventional shot medium is adopted, and the shot peening is carried out at a higher injection speed than a conventional method by using compressed air. By this shot peening, fatigue life is improved by about 5 to 10 times compared to conventional shot peening.

### SUMMARY

The manufacturing method described in Japanese Patent Application Laid-Open No. 2006-188720 may present a risk that the fatigue strength of the aluminum alloy member decreases over time. Due to shot peening, strain is introduced in an interior (surface layer) of the aluminum alloy member, and residual stress (residual compressive stress) is imparted thereto. This residual stress is released when a β-phase is formed on the strain. Because the aluminum alloy member contains an element that generates the n-phase, a β-phase compound precipitates in the aluminum alloy as time elapses. When the β-phase compound is precipitated, the strain in the interior of the aluminum alloy member is relieved. As the residual stress is released over time, the fatigue strength of the aluminum alloy member decreases. The present disclosure provides a technique capable of appropriately maintaining the fatigue strength of the aluminum alloy member.

According to one aspect of the present disclosure, a manufacturing method for an aluminum alloy member includes preparing an aluminum alloy member composed of an aluminum alloy, and performing shot peening on the aluminum alloy member in a range in which a speed of the shot when contacting the aluminum alloy member is from 1 m/s to 7 m/s to impart residual stress to the aluminum alloy member.

Another aspect of the present disclosure is a shot peening apparatus for performing shot peening on an aluminum alloy member composed of an aluminum alloy. The shot peening apparatus includes a hopper configured to store the shot, a pipe member configured to communicate with the hopper and allow the shot to pass through, and a support member disposed vertically below a lower end of the pipe member and configured to support the aluminum alloy member.

According to the present disclosure, it is possible to appropriately maintain the fatigue strength of the aluminum alloy member.

### BRIEF DESCRIPTION OF DRAWINGS

FIG. 1 is a flowchart of a manufacturing method according to an embodiment.

FIG. 2 is a diagram illustrating an example of a shot peening apparatus according to an embodiment.

FIG. 3 is a diagram illustrating another example of a shot peening apparatus according to an embodiment.

FIG. 4 is a graph illustrating residual stress imparted by using a first shot and a second shot.

FIG. 5 is a graph illustrating relationships between the residual stress of the aluminum alloy member and elapsed time in examples and comparative examples.

FIG. 6 is a graph illustrating relationships between the residual stress of the aluminum alloy member and elapsed time, obtained for each shot speed.

FIG. 7 is a graph illustrating relationships between stress amplitude and number of cycles for the aluminum alloy member in examples and comparative examples.

### DETAILED DESCRIPTION

Hereinafter, embodiments of the present disclosure will be described in detail with reference to the drawings. In the description of the drawings, the same reference signs are assigned to the same or equivalent elements, and redundant description is omitted. Dimensional ratios shown in the drawings do not necessarily match those in actual implementations. The terms “upper,” “lower,” “left,” and “right” are based on the illustrated state for convenience.

### Overview of Manufacturing Method for Aluminum Alloy Member

In a manufacturing method according to the present disclosure, an aluminum alloy member to which residual stress is imparted is manufactured. The aluminum alloy member thus manufactured is applicable to articles handled by human users, such as sports equipment (bicycles, golf clubs, fishing gear, bats, etc.), work implements (agricultural machinery, gardening tools, etc.), and everyday items (wheelchairs, eyeglasses, chairs, etc.). These products may obtain sufficient performance even with a lower fatigue strength (for example, 50 MPa to 350 MPa or 70 MPa to 300 MPa) than automobile parts, railway parts, or aircraft parts.

The residual stress imparted to the aluminum alloy member is gradually released over time. The aluminum alloy member is composed of an aluminum alloy. In the aluminum alloy, a β-phase compound is precipitated as time elapses. When the aluminum alloy contains at least one element selected from among Mg, Cu, Mn, and Si, a β-phase compound is likely to form on the strain introduced into the aluminum alloy member, as a result of reactions between aluminum and these elements. During precipitation of the β-phase compound, the strain in the aluminum alloy member is relaxed and the residual stress is released. When the residual stress is released over time, the fatigue strength of the aluminum alloy member decreases. Below, a manufacturing method capable of appropriately maintaining the fatigue strength of the aluminum alloy member will be described.

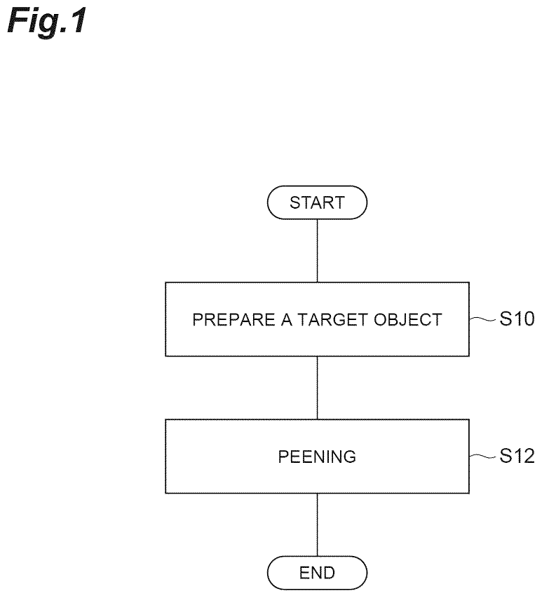

FIG. 1 is a flowchart of a manufacturing method according to an embodiment. As shown in FIG. 1, at Step S10, a target object is prepared. The target object is the aluminum alloy member composed of an aluminum alloy, and the aluminum alloy may contain at least one element selected from among Mg, Cu, Mn, and Si.

Next, at Step S12, peening is performed on the target object. The peening here is shot peening. The shot (shot media) having a high specific gravity is adopted. For example, a specific gravity of the shot is 3.8 or more. Although the upper limit for the specific gravity of the shot is not particularly limited, it may be 6.0 or less, for example. The shot may have a specific gravity of from 3.8 to 6.0 and a Vickers hardness in a range from HV600 to HV1200. One example of a material meeting this specific gravity and Vickers hardness is zirconia. The shot can be spherical, and a diameter φ of the shot may be from 0.05 mm to 2.0 mm.

In this shot peening, the shot is brought into contact with the target object at a low speed. As one specific example, when the shot contacts the aluminum alloy member, the speed of the shot may be in a range from 1 m/s to 7 m/s. By making the speed of the shot 1 m/s to 7 m/s, it becomes possible to suppress the release of imparted residual stress. When the speed of the shot is less than 1 m/s, the residual stress immediately after peening is only around −100 MPa, which is small, and the effect of suppressing release of residual stress becomes extremely small. When the speed of the shot exceeds 7 m/s, the effect of suppressing release of residual stress becomes lower compared with the case of setting the shot speed to 1 m/s to 7 m/s. Note that the shot speed may be within 1.0 m/s to 6.5 m/s or may be within 1 m/s to 5 m/s. By setting the shot speed to 1 m/s to 5 m/s, the effect of suppressing the release of residual stress becomes more stable, and the change in residual stress over time is reduced, facilitating quality control. The range of these shot speeds may be realized using a blower instead of compressed air, or by dropping the shot freely from above the aluminum alloy member to allow the shot to reach the aluminum alloy member. Through this shot peening, residual stress is imparted to the aluminum alloy member.

Once Step S12 is finished, the flowchart shown in FIG. 1 ends. By the manufacturing method shown in FIG. 1, release of the residual stress in the aluminum alloy member is reduced, and the fatigue strength of the aluminum alloy member is appropriately maintained. Although the reason why the residual stress of the aluminum alloy member is less prone to release remains unclear, test results indicate that the release ratio of the residual stress (i.e., {(residual stress at a first timing)−(residual stress at a second timing)}÷(residual stress at the first timing)×100) is 15% or less between a first timing at which a predetermined time T1 has elapsed following completion of a series of operations and a second timing at which a predetermined time T2 has elapsed following the completion of the series of operations, and that the residual stress thereafter almost stops decreasing. Here, T1>=0 and T1<T2. For example, T1 may be 20 hours and T2 may be 160 hours.

Furthermore, since the shot peening can be realized without using compressed air, no compressor is required. Therefore, according to the manufacturing method shown in FIG. 1, the energy consumption efficiency in a factory is enhanced and CO₂ can be reduced.

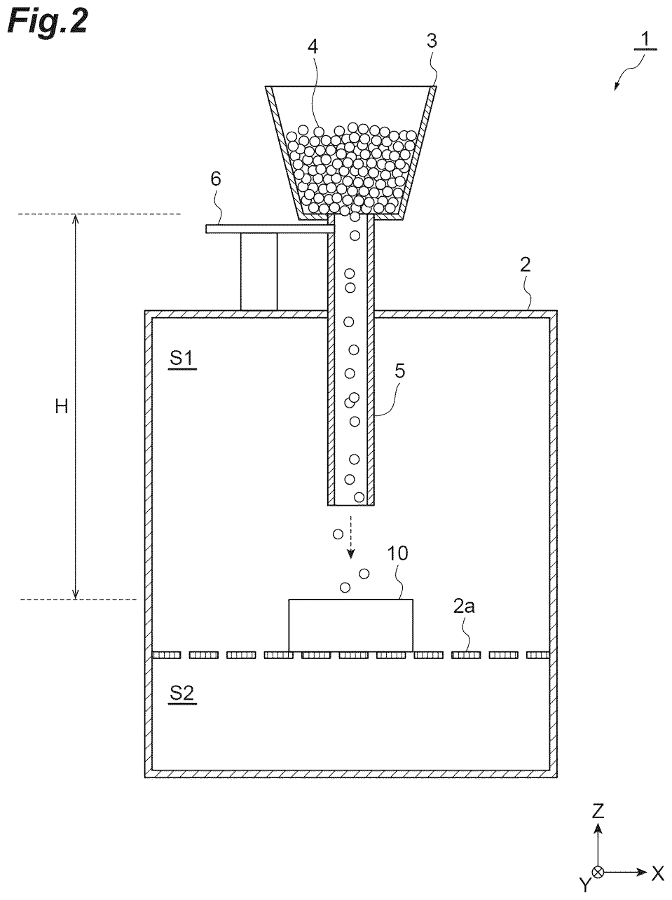

Overview of Shot Peening Apparatus A shot peening apparatus that can be used in Step S12 shown in FIG. 1 will now be exemplified. FIG. 2 is a diagram illustrating an example of a shot peening apparatus according to an embodiment. The shot peening apparatus 1 shown in FIG. 2 includes a chamber 2. The chamber 2 is hollow. An aluminum alloy member 10, which is the object to be treated, is placed inside the chamber 2.

Above the chamber 2, a hopper 3 is provided. The hopper 3 stores shot 4. The shot 4 is the shot having a specific gravity of 3.8 or more. The specific gravity of the shot may be 6.0 or less. A pipe member 5, which communicates with the hopper 3 and allows the shot 4 to pass therethrough, is provided at the lower end of the hopper 3. The lower end of the pipe member 5 communicates with the inside of the chamber 2. An open-close gate 6 is provided on the pipe member 5. When the open-close gate 6 is opened, the shot 4 stored in the hopper 3 freely falls, passes through the pipe member 5, and reaches the inside of the chamber 2. Inside the chamber 2, a support member 2a is arranged to support the aluminum alloy member 10. The support member 2a is disposed vertically below the lower end of the pipe member 5. The shot 4 that freely falls is guided by the pipe member 5 and is projected onto the aluminum alloy member 10. The speed of the shot 4 when contacting the aluminum alloy member 10 may be defined by the height from the open-close gate 6 to the aluminum alloy member 10.

The interior of the chamber 2 may be partitioned by the support member 2a into a treatment chamber S1 and a recovery chamber S2. In this case, the support member 2a has multiple openings through which the shot 4 can pass. The shot 4 projected onto the aluminum alloy member 10 passes through the support member 2a and is collected in the recovery chamber S2. The shot 4 collected in the recovery chamber S2 is conveyed to the hopper 3 by a conveying device (not illustrated).

According to the shot peening apparatus 1, by selecting the combination of the specific gravity of the shot 4 and the height from the open-close gate 6 to the aluminum alloy member 10, the speed of the shot 4 when contacting the aluminum alloy member 10 can be set in the range of 1 m/s to 7 m/s. Thus, the residual stress of the aluminum alloy member 10 becomes less prone to release, and the fatigue strength of the aluminum alloy member 10 is appropriately maintained. Moreover, in the shot peening apparatus 1 shown in FIG. 2, shot peening can be realized without using compressed air, so no compressor is required. Consequently, the energy consumption efficiency in a factory is enhanced, and CO₂ can be reduced.

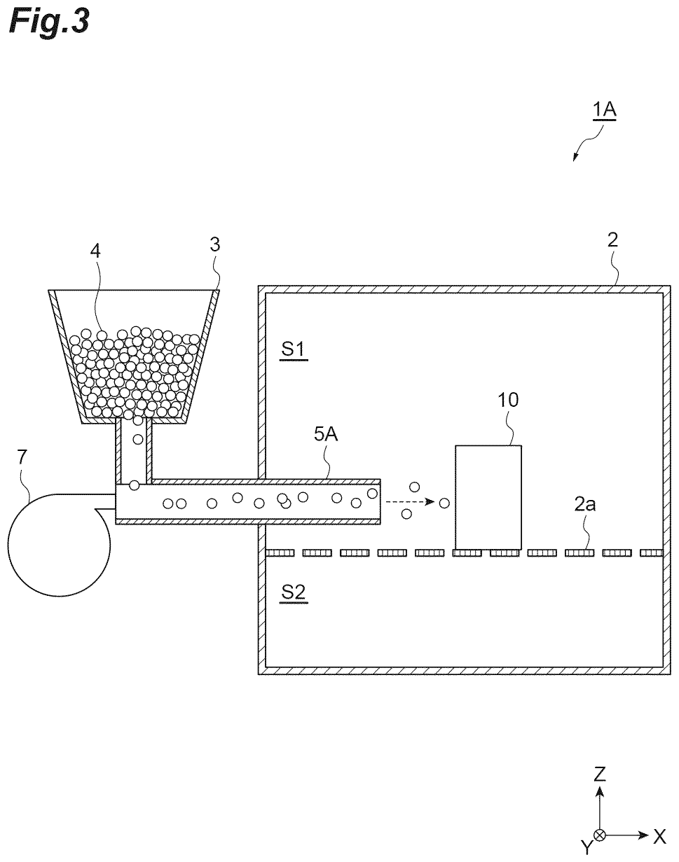

Next, another shot peening apparatus that can be used in Step S12 shown in FIG. 1 will be exemplified. FIG. 3 is a diagram illustrating another example of a shot peening apparatus according to an embodiment. Compared with the shot peening apparatus 1 shown in FIG. 2, the shot peening apparatus 1A shown in FIG. 3 differs in the arrangement of the hopper, the arrangement of the pipe member, and that a blower 7 is provided on the pipe member; otherwise, the configuration is the same. Below, differences are mainly described, and redundant description is omitted.

The hopper 3 is disposed on a side of the chamber 2. At the lower end of the hopper 3, a pipe member 5A is provided so as to communicate with the hopper 3 and allow the shot 4 to pass therethrough. The pipe member 5A is bent at its distal end, extending from the lower end of the hopper 3 to the side wall of the chamber 2, and communicates with the inside of the chamber 2. A blower 7 is provided in the pipe member 5A. The blower 7 is equipment that sends air without using compressed air. By blowing air with the blower 7, the shot 4 stored in the hopper 3 passes through the pipe member 5A and reaches the inside of the chamber 2. The shot 4 is guided in a horizontal direction by the pipe member 5A and is projected onto the side surface of the aluminum alloy member 10. The speed of the shot 4 when contacting the aluminum alloy member 10 can be defined by the amount of air delivered and can be adjusted within the range of 1 m/s to 7 m/s. According to the shot peening apparatus 1A, as in the shot peening apparatus 1, the fatigue strength of the aluminum alloy member 10 can be appropriately maintained, and the energy consumption efficiency of the factory can be improved while reducing CO₂.

While various exemplary embodiments have been described above, the present disclosure is not limited to the foregoing exemplary embodiments, and various omissions, substitutions, combinations, and changes may be made.

For example, the shot peening apparatus 1A may employ a centrifugal projector in place of the blower 7.

### EXAMPLES

The advantages of the manufacturing method and apparatus of the present disclosure will be described below based on examples and comparative examples.

### (Verification of Shot Capable of Imparting Residual Stress)

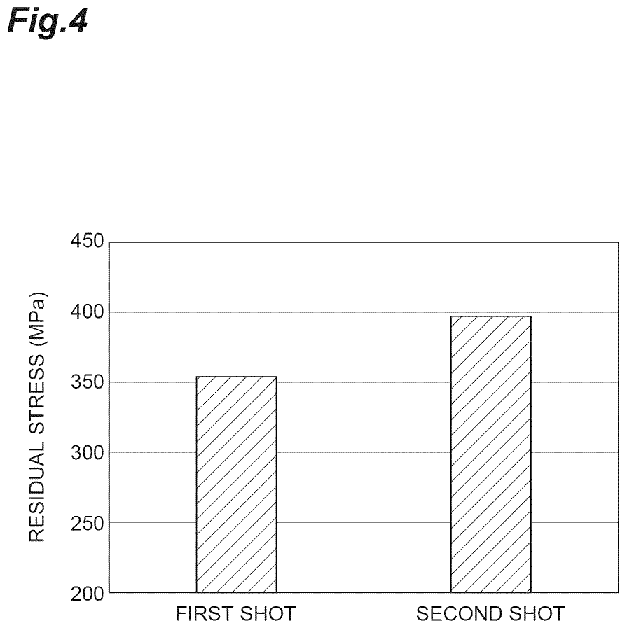

An aluminum alloy member composed of the aluminum alloy specified in JIS (Japanese Industrial Standards) A7075 was prepared. Then, a free-fall shot peening was performed on the aluminum alloy member using the shot peening apparatus 1 shown in FIG. 2. In this shot peening, a first shot having a specific gravity of 3.8 and a Vickers hardness of HV600 and a second shot having a specific gravity of 6.0 and a Vickers hardness of HV1200 were used. The residual stress of the aluminum alloy member after treatment with the first shot and the residual stress of the aluminum alloy member after treatment with the second shot were measured, respectively. An X-ray residual stress measurement device (model μ-X360s manufactured by Pulstec Industrial Co., Ltd.) was used for measurement. The results are shown in FIG. 4.

FIG. 4 is a graph illustrating the residual stress imparted by using the first shot and the second shot. The vertical axis represents the absolute value of the residual stress. As shown in FIG. 4, the residual stress imparted by using the first shot was about 350 MPa, and the residual stress imparted by using the second shot was about 400 MPa. From this, it was confirmed that a shot having a specific gravity of 3.8 or more and a Vickers hardness of HV600 or more can impart sufficient residual stress.

### (Verification of Maintaining Residual Stress)

### Example 1

As Example 1, an aluminum alloy member composed of the aluminum alloy specified in JIS A7075 was prepared. Then, a free-fall shot peening was carried out on the aluminum alloy member using the shot peening apparatus 1 shown in FIG. 2. In this shot peening, shot having a spherical shape with a diameter φ ranging from 0.6 mm to 0.8 mm, composed of zirconia, having a specific gravity of 6.2, and having a Vickers hardness of HV1180 was used.

### Comparative Example 1

In Comparative Example 1, the same aluminum alloy member as used in Example 1 was prepared. Next, shot peening was performed using a shot peening apparatus (ABT-type manufactured by Sintokogio, Ltd.). In this shot peening, spherical shot with a diameter of 0.6 mm, composed of cast steel, having a specific gravity of 7.5, and having a Vickers hardness of HV600 was used. The shot peening condition included an injection pressure of 0.1 MPa and an injection amount of shot media of 5 kg/min.

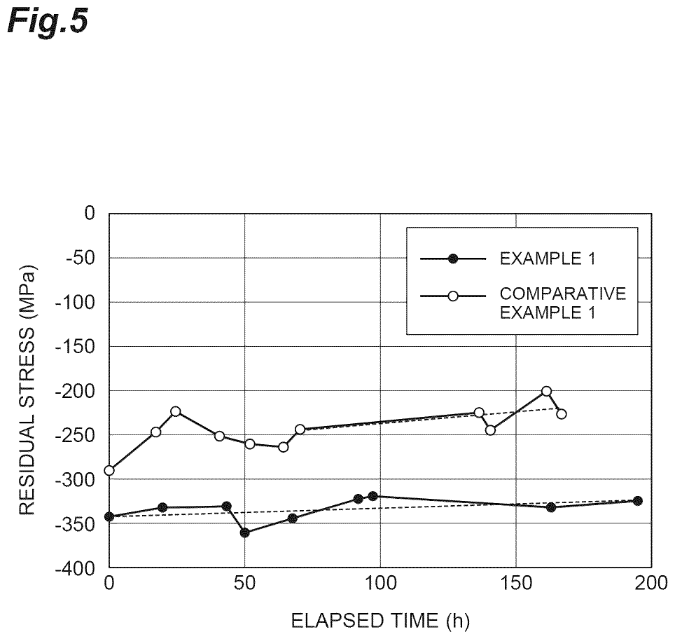

For the aluminum alloy members of Example 1 and Comparative Example 1, changes in residual stress over time were measured. An X-ray residual stress measurement device (model μ-X360s manufactured by Pulstec Industrial Co., Ltd.) was used for measuring the residual stress. The measurement was performed multiple times from 0 hours to 200 hours. The results are shown in FIG. 5.

FIG. 5 is a graph illustrating relationships between the residual stress of the aluminum alloy member and elapsed time in the example and comparative example. The vertical axis of FIG. 5 represents the residual stress of the aluminum alloy member, and the horizontal axis represents elapsed time. In FIG. 5, tensile residual stress is indicated by positive values, and compressive residual stress is indicated by negative values. As shown in FIG. 5, the aluminum alloy member of Comparative Example 1 exhibited a residual stress of −280 MPa immediately after shot peening (0 hours), which gradually relaxed over time. At 20 hours and 160 hours after shot peening, the residual stress was −245 MPa and −200 MPa, respectively. When setting the first timing to 20 hours and the second timing to 160 hours, the release ratio of the residual stress was 18.3%, exceeding 15%.

In contrast, the aluminum alloy member of Example 1 exhibited a residual stress of −345 MPa immediately after shot peening, and generally retained about the same value even as time elapsed. At 20 hours and 160 hours after shot peening, the residual stress was −330 MPa, and the asymptotic lines (shown in dotted lines in FIG. 5) were −340 MPa and −325 MPa, respectively. The release ratio of the residual stress was 0% (or 4.4% when estimated by the asymptote), which was 15% or less. These results confirmed that the aluminum alloy member manufactured in Example 1 was less prone to release the compressive residual stress.

### (Verification of Relationship Between Shot Speed and Maintenance of Residual Stress)

### Example 2

As Example 2, an aluminum alloy member composed of the aluminum alloy specified in JIS A7075 was prepared. Then, a free-fall shot peening was carried out on the aluminum alloy member using the shot peening apparatus 1 shown in FIG. 2. The free-fall height (difference in height between the position at which the shot starts to fall and the aluminum alloy member) was set to 1 m. That is, the speed of the shot when contacting the aluminum alloy member was 4.4 m/s. In this shot peening, spherical shot with a diameter φ of 0.6 mm to 0.8 mm, composed of zirconia, having a specific gravity of 6.2, and having a Vickers hardness of HV1180 (ZC600 manufactured by Sintokogio, Ltd.) was used.

### Example 3

In Example 3, the free-fall height was set to 2 m, i.e., the speed of the shot when contacting the aluminum alloy member was 6.3 m/s. Other conditions were the same as those of Example 2.

### Comparative Example 2

In Comparative Example 2, the free-fall height was set to 3 m, i.e., the shot speed when contacting the aluminum alloy member was 7.7 m/s. Other conditions were the same as Example 2.

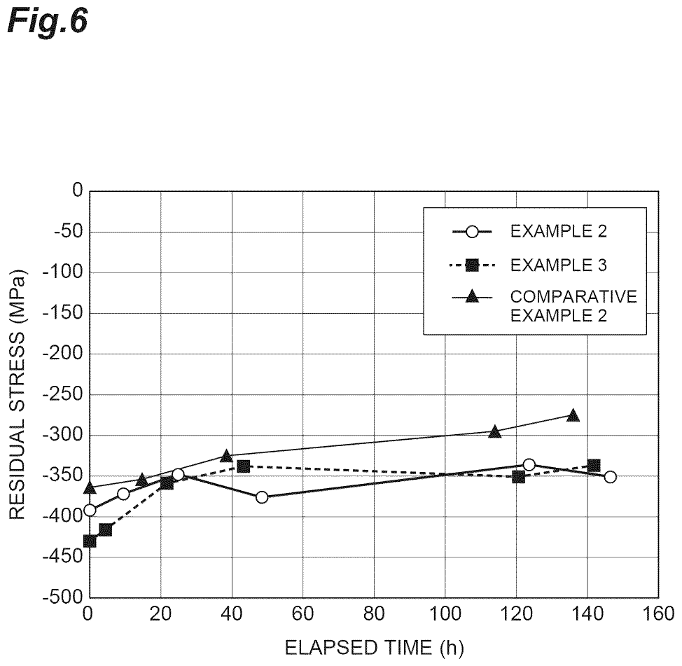

For the aluminum alloy members of Examples 2 and 3 and Comparative Example 2, changes in residual stress over time were measured. An X-ray residual stress measurement device (model μ-X360s manufactured by Pulstec Industrial Co., Ltd.) was used to measure the residual stress. The measurement was performed multiple times from 0 hours to 150 hours. The results are shown in FIG. 6.

FIG. 6 is a graph illustrating the relationships between the residual stress of the aluminum alloy member and elapsed time, obtained for each of the shot speeds. The vertical axis of FIG. 6 represents the residual stress of the aluminum alloy member, and the horizontal axis represents time. In FIG. 6, tensile residual stress is indicated by positive values, and compressive residual stress is indicated by negative values. As shown in FIG. 6, in the aluminum alloy member of Comparative Example 2 (7.7 m/s), the residual stress was −360 MPa immediately after shot peening (0 hours) and gradually relaxed over time. Because the change rate was not stable in Comparative Example 2, it is assumed that the residual stress would relax further as time progressed. From the graph, it can be inferred that at 20 hours and 160 hours after shot peening, the residual stress was about −350 MPa and about −270 MPa, respectively. In other words, between the first timing (20 hours) and the second timing (160 hours), approximately −80 MPa of residual stress was relaxed. The release ratio of the residual stress was 22.8%, exceeding 15%.

In contrast, in the aluminum alloy member of Example 2 (4.4 m/s), the residual stress was −400 MPa immediately after shot peening, and it generally retained about the same value after 20 hours of elapsed time. At 20 hours and 145 hours after shot peening, the residual stress was −355 MPa and −350 MPa, respectively. When the residual stress at 145 hours is used, the release ratio of the residual stress is 1.4%. Considering the stability of the residual stress after 20 hours, it is assumed that the release ratio would not significantly change from 1.4%.

Similarly, in the aluminum alloy member of Example 3 (6.3 m/s), the residual stress was −425 MPa immediately after shot peening and generally retained about the same value after 20 hours. At 20 hours and 140 hours after shot peening, the residual stress was −365 MPa and −340 MPa, respectively. When the residual stress at 140 hours is used, the release ratio of the residual stress is 6.8%. Considering the stability of the residual stress after 20 hours, it is assumed that the release ratio would not significantly change from 6.8%.

From the above, it was confirmed that the aluminum alloy members manufactured in Examples 2 and 3 were less prone to release the compressive residual stress.

### (Verification of Maintaining Fatigue Strength)

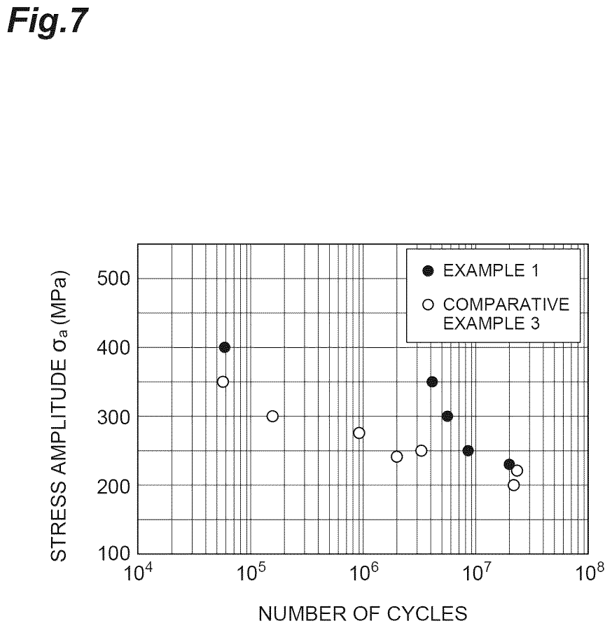

The fatigue strength was evaluated for the aluminum alloy member of Example 1 and an untreated aluminum alloy member (Comparative Example 3). The aluminum alloy member of Example 1 that had elapsed 168 hours after shot peening was used. For evaluation of fatigue strength, a repeated stress was periodically applied to the aluminum alloy member, and a stress amplitude σₐ was measured. A measuring device (MS-CRB-0 manufactured by Kazuki Co., Ltd.) was used for measuring the stress amplitude σₐ. The results are shown in FIG. 7.

FIG. 7 is a graph illustrating the relationships between stress amplitude and number of cycles for the aluminum alloy member in the example and comparative example. The vertical axis in FIG. 7 represents the stress amplitude σₐ, and the horizontal axis represents the number of cycles. As shown in FIG. 7, the stress amplitude σₐ in Example 1 remained at a higher level until the number of cycles reached several million, compared with the stress amplitude σₐ in Comparative Example 3. From these results, it was confirmed that the aluminum alloy member manufactured in Example 1 maintained its fatigue strength sufficiently for articles handled by human users.

### Embodiments Included in the Present Disclosure

The present disclosure includes the following clauses:
(Clause 1) According to one aspect, a manufacturing method for an aluminum alloy member comprises: preparing an aluminum alloy member composed of an aluminum alloy; and performing shot peening on the aluminum alloy member in a range in which a speed of the shot when contacting the aluminum alloy member is from 1 m/s to 7 m/s, to impart residual stress to the aluminum alloy member.

According to the manufacturing method in clause 1, shot peening is performed on the aluminum alloy member in a range in which the speed of the shot when contacting the aluminum alloy member is from 1 m/s to 7 m/s. Such a shot speed range of 1 m/s to 7 m/s can be realized without using compressed air. When residual stress is imparted to an aluminum alloy by ordinary cold working, aging relaxation can occur. The residual stress imparted to the aluminum alloy member is released as time elapses, causing the fatigue strength to decrease over time. The inventors have found that a specific shot peening condition of bringing the shot into contact with the aluminum alloy member at a low speed helps suppress the time-dependent decrease in the fatigue strength of the aluminum alloy member. With this specific shot peening condition, the manufacturing method in clause 1 can appropriately maintain the fatigue strength of the aluminum alloy member. Furthermore, because the shot peening is realized without using compressed air, no compressor is required. Hence, the manufacturing method in clause 1 can improve the energy consumption efficiency in a factory and contribute to reducing CO₂ emissions.
(Clause 2) In the manufacturing method according to clause 1, a specific gravity of the shot may be 3.8 or more. By using heavier shot having a specific gravity of 3.8 or more, even a low speed can produce a sufficient shot peening effect.
(Clause 3) In the manufacturing method according to clause 2, the shot may have a Vickers hardness in a range from HV600 to HV1200. By using shot whose specific gravity is 3.8 or more and whose Vickers hardness is in a range from HV600 to HV1200, an even more sufficient shot peening effect can be achieved at a low speed.
(Clause 4) In the manufacturing method according to clause 3, the shot may be composed of zirconia. According to the manufacturing method in clause 4, the fatigue strength of the aluminum alloy member can be appropriately maintained by using shot composed of zirconia.
(Clause 5) In the manufacturing method according to any one of clauses 1 to 4, in the step of imparting the residual stress, the shot may be dropped freely from above the aluminum alloy member so as to reach the aluminum alloy member. The manufacturing method in clause 5 can further improve energy consumption efficiency in a factory and contribute further to reducing CO₂.
(Clause 6) In the manufacturing method according to any one of clauses 1 to 5, a residual stress of the aluminum alloy member that has undergone shot peening may be from 50 MPa to 350 MPa. According to the manufacturing method in clause 6, a suitable fatigue strength can be imparted to the aluminum alloy member used in articles handled by human users.
(Clause 7) In the manufacturing method according to clause 6, a release ratio of the residual stress of the aluminum alloy member from a first timing at which a predetermined time has elapsed since the shot peening was performed on the aluminum alloy member to a second timing is 15% or less. The first timing is the point in time when a predetermined time (T1) has elapsed since completion of a series of operations, and the second timing is the point in time when a predetermined time (T2) has elapsed since completion of the series of operations. The release ratio of the residual stress is calculated by {(residual stress at the first timing)−(residual stress at the second timing)}÷(residual stress at the first timing)×100. A smaller value indicates that over time the residual stress is less likely to be released, and an appropriate fatigue strength can be stably maintained. According to the manufacturing method in clause 7, the fatigue strength imparted to the aluminum alloy member used in articles handled by human users can be appropriately maintained.
(Clause 8) According to another aspect of the present disclosure, a shot peening apparatus for performing shot peening on an aluminum alloy member composed of an aluminum alloy comprises: a hopper configured to store the shot; a pipe member configured to communicate with the hopper and allow the shot to pass through; and a support member disposed vertically below a lower end of the pipe member and configured to support the aluminum alloy member.

According to the shot peening apparatus in clause 8, the shot freely falls from the pipe member and strikes the aluminum alloy member supported vertically below the pipe member. The inventors have found that the specific shot peening condition of contacting the aluminum alloy member with the shot at a low speed contributes to suppressing a time-dependent decrease in the fatigue strength of the aluminum alloy member. According to the free-fall-type shot peening apparatus in clause 8, the fatigue strength of the aluminum alloy member can be appropriately maintained. Furthermore, because shot peening is realized without using compressed air, no compressor is required. Thus, the free-fall-type shot peening apparatus in clause 8 improves energy consumption efficiency in a factory and contributes to CO₂ reduction.

What is claimed is:

1. A manufacturing method for an aluminum alloy member comprising:
preparing an aluminum alloy member composed of an aluminum alloy; and
performing shot peening on the aluminum alloy member in a range in which a speed of the shot when contacting the aluminum alloy member is from 1 m/s to 7 m/s to impart residual stress to the aluminum alloy member.

2. The manufacturing method according to claim 1, wherein a specific gravity of the shot is 3.8 or more.

3. The manufacturing method according to claim 2, wherein the shot has a Vickers hardness in a range from HV600 to HV1200.

4. The manufacturing method according to claim 3, wherein the shot is composed of zirconia.

5. The manufacturing method according to claim 1, wherein, in the performing, the shot is dropped freely from above the aluminum alloy member so as to reach the aluminum alloy member.

6. The manufacturing method according to claim 1, wherein a residual stress of the aluminum alloy member that has undergone shot peening is from 50 MPa to 350 MPa.

7. The manufacturing method for an aluminum alloy member according to claim 6, wherein a release ratio of the residual stress of the aluminum alloy member from a first timing at which a predetermined time has elapsed since shot peening was performed on the aluminum alloy member to a second timing is 15% or less.

8. A shot peening apparatus for performing shot peening on an aluminum alloy member composed of an aluminum alloy comprising:
a hopper configured to store shot;
a pipe member configured to communicate with the hopper and allow the shot to pass through; and
a support member disposed vertically below a lower end of the pipe member and configured to support the aluminum alloy member.
